(19) United States
(12) Patent Application Publication
(10) Pub. No.: US 2005/0098996 A1
(43) Pub. Date: May 12, 2005

(54) Knee bolster cover

(76) Inventor: Mark L. Enders, Pleasant View, UT (US)

Correspondence Address: Sally J. Brown;AUTOLIV ASP, INC., 3350 Airport Road, Ogden, UT, 84405, US

(21) Appl. No.: 10/703,119

(22) Filed: Nov. 6, 2003

(51) Int. Cl. B60R 21/04

(52) U.S. Cl. 280/751

(57) ABSTRACT

The knee bolster cover of the present invention includes a knee bolster region and a peripheral region. A portion of the knee bolster region separates from a remainder of the cover during expansion of an attached inflatable chamber to receive an occupant impact. The peripheral region covers and provides an interface for components of a vehicle situated proximate the inflatable chamber, such as a hood latch or an air vent. Accordingly, the knee bolster region is formed from a first material that satisfies stringent engineering requirements needed to receive an occupant impact. The peripheral region is made from a second material and is required only to meet the lower standards needed for decorative molding within a vehicle. The knee bolster region and peripheral region are bonded together during the molding process to form a unitary knee bolster cover.

### BACKGROUND OF THE INVENTION

1. Field of the Invention

The present invention relates to cosmetic covers for airbags. More specifically, this invention relates to an integrated cosmetic cover for a knee bolster.

2. Description of Related Art

Inflatable airbags are well accepted for use in motor vehicles and have been credited with preventing numerous deaths and injuries. Some statistics estimate that frontal airbags reduce the fatalities in head-on collisions by 25% among drivers using seat belts and by more than 30% among unbelted drivers. Statistics further suggest that with a combination of a seat belt and an airbag, serious chest injuries in frontal collisions can be reduced by 65% and serious head injuries by up to 75%. Airbag use presents clear benefits and vehicle owners are frequently willing to pay the added expense for airbags. In addition, the inclusion of inflatable safety restraint devices, or airbags, is now a legal requirement for many new vehicles.

Airbag systems typically include three principal components: an electronic control unit (ECU), an inflator, and an inflatable cushion. The ECU monitors the acceleration and deceleration of the vehicle and determines when accident conditions exist. The ECU is in communication with the inflator and transmits a signal to the inflator when the ECU determines that the vehicle has been involved in an accident.

In response to receipt of the signal, the inflator generates inflation gas. The inflator can be designed to produce inflation gas using various methods. For instance, the inflator may use pyrotechnic techniques or simply release compressed gas. In addition, the inflator may use a combination of both pyrotechnics and compressed gas to produce pressurized inflation gas. The inflator is in fluid communication with the inflatable cushion.

Prior to deployment, the inflatable cushion is housed within an airbag cover. The cover both protects the inflatable cushion from damage and provides a cosmetic cover to the cushion. When the inflatable cushion receives the gas generated by the inflator, the cushion expands. In response to expansion of the cushion, the cover opens to permit the cushion to fully deploy.

As experience with the manufacture and use of airbags has progressed, the engineering challenges involved in their design, construction, and use have become better understood. Most airbag systems are designed to rapidly inflate and provide a cushion in front of or alongside an occupant based on a presumption that the occupant will be in a predetermined position. Problems have been observed when the occupant is “out of position” when a collision occurs and the airbag deploys. Similar problems may occur when the occupant is deflected away from the airbag before proper deceleration can occur.

Out-of-position injuries may be attributed in part to the fact that most airbag systems deploy in front of the torso of an occupant. More specifically, these conventional airbags deploy between the upper torso of an occupant and the windshield and instrument panel. During a front-end collision, there is a tendency for an occupant, particularly one who is not properly restrained by a seat belt, to slide forward along the seat. This results in poor kinematics and positioning when the occupant interacts with a frontal airbag, such as a driver or a passenger's side airbag.

In order to improve occupant protection, knee airbag systems have been developed. These airbags systems deploy during a collision and engage an occupant's knees or lower legs. These systems hold the occupant in place on the seat, and improve the kinematics of the occupant.

Such knee airbag systems may include a knee airbag and a knee bolster cover, which is disposed in front of the knee airbag. The addition of a knee bolster cover to the system provides a rigid surface area to better engage and decelerate the knees or legs of an occupant and thereby provide superior restraint to the occupant's lower body. Additionally, the knee bolster cover allows some degree of deformation to minimize the impact of an occupant.

Accordingly, the knee bolster cover must satisfy stringent engineering requirements to perform as required upon deployment of the knee airbag. Thus, the knee bolster cover must be made from a high quality material that satisfies these engineering requirements. Unfortunately, these high quality materials are generally two to three times more expensive than the commodity plastics from which interior, decorative panels are made.

Furthermore, the knee bolster cover often covers and provides an interface with other components of the vehicle besides the knee airbag. For example, the knee bolster cover may be required to provide interfaces for components of the vehicle disposed underneath or near the steering wheel, such as air vents, storage compartments, or hood release latches. As a result, the materials that satisfy the high engineering requirements of a knee bolster cover must be used to cover and interface with these peripheral components of the vehicle. As a consequence, the knee bolster cover can be substantial in size and thus expensive.

Moreover, the use of a separate knee bolster cover and surrounding decorative cover creates additional labor, part, and design expenses. For example, additional brackets are required to secure the knee bolster cover and surrounding decorative cover to the vehicle. Moreover, it is labor intensive and time consuming to install two panels, as opposed to one panel, in a vehicle. The design expenses also increase because the installation order and process of the two panels must be considered in designing these types of covers. When these additional expenses are incurred with respect to a large number of vehicles, the total expense can be substantial.

Accordingly, there is a need in the art for a novel knee bolster cover that addresses one or more of the above-listed problems. Such a cover is disclosed herein.

### SUMMARY OF THE INVENTION

The apparatus of the present invention has been developed in response to the present state of the art, and in particular, in response to problems and needs in the art that have not yet been fully solved by currently available knee bolster covers. The knee bolster cover of the present invention resolves these concerns in that it is cost-effective and yet satisfies the stringent engineering requirements of a knee bolster cover.

The knee bolster cover of the present invention may be designed in a wide variety of configurations. For example, the knee bolster cover may be used in connection with passenger or driver's side knee bolsters. Accordingly, the knee bolster cover may be integrated with a glove compartment on the passenger side of the vehicle or may be disposed below the glove compartment. The knee bolster cover may also be positioned below the steering wheel of a vehicle.

The knee bolster cover includes a knee bolster region and a peripheral region. The knee bolster region may have a generally planar exposed surface. In alternative embodiments, the knee bolster region may have a rounded or curved exposed surface.

In one embodiment, the peripheral region extends in a generally lateral direction away from the knee bolster region. The peripheral region and knee bolster region may be generally coplanar. In alternative embodiments, the peripheral region is angled or offset with respect to the knee bolster cover. The knee bolster region and peripheral regions may have a generally curved shape, as is commonly found in the lower portion of a passenger's side dashboard. The peripheral region may be disposed entirely around the knee bolster region or may extend around only a portion of the knee bolster region.

The peripheral region interfaces with and provides a cosmetic cover to components of a vehicle disposed proximate an inflatable chamber, which is attached to the knee bolster region of the cover. Thus, the peripheral region may include various interfaces, such as a hood latch interface, an air vent interface, a storage compartment interface, and a steering wheel inlet. The peripheral region is versatile and may be designed to interface with a wide variety of components in a vehicle.

The cover may include a tear seam. The tear seam is disposed around at least a portion of the knee bolster region. The tear seam can be positioned entirely within the knee bolster region. In an alternative embodiment, the tear seam is disposed between the knee bolster region and the peripheral region. The tear seam ruptures to permit a portion of the knee bolster region to separate from the remainder of the cover and receive an occupant impact.

The knee bolster region is made from a first material, and the peripheral region is made from a second material. The first material has higher performance requirements than the second material because the portion of the knee bolster region is displaced and receives an occupant impact during an accident. The second material, in contrast, is required only to meet the lower standards needed for decorative molding within a vehicle.

Those skilled in the art will recognize that the first and second materials may comprise a wide variety of compounds, mixtures, or substances to achieve the purposes delineated above. For example, the first material may comprise high performance polymers, such as styrene-ethylene-butylene-styrene copolymers (SEBS), styrene block copolymers, styrene-butadiene copolymers, polyolefin elastomers, polyesters, or nylons. Polyolefin elastomers include, for example, polyethylene and polypropylene elastomers. In contrast, the second material may comprise what is frequently referred to as commodity plastics, such as polypropylene, polyethylene, acrylonitrile butadiene styrene (ABS), polyvinyl chloride (PVC), and acrylonitrile butadiene styrene (ABS)/polycarbonate (PC) alloys.

In one embodiment, the first material has a greater density than the second material. For example, the first material may be 10 to 20% more dense than the second material. In addition, the first material may have a lower flex modulus and tensile strength than the second material. In one embodiment, the second material has a tensile strength of 4400-6300 psi and a flex modulus of 179-375 Kpsi, while the first material has a tensile strength of 1250-2200 psi and a flex modulus of 11-60 Kpsi. In one embodiment, the first material is more flexible and/or elastic than the second material. For example, the first material may have a percentage elongation at yield in excess of 300%, while the second material may have a percentage elongation at break of only 5-75%.

The high-quality materials from which the knee bolster region is made are not required for the peripheral region. Accordingly, significant cost savings can be achieved by using commodity grade plastics for the peripheral region.

The knee bolster region and peripheral region are bonded together during a molding process. Thus, a two- or multi-shot molding process is used. Alternatively, a simultaneous co-injection process could be used to form the cover.

To achieve a bond during the molding process, the first and second materials should be compatible with each other. For example, if polymeric alloys are used, one component of each alloy should be common to the first and second materials. A polymeric alloy is a blend of two or more polymers. Acrylonitrile butadiene styrene (ABS)/polycarbonate (PC) is one example of a polymeric alloy.

The inflatable chamber used in connection with the present invention may be embodied in a number of different ways. In one embodiment, the inflatable chamber is made from a malleable material, such as steel or a polymer. Alternatively, the inflatable chamber may be made from a flexible material, such as fabric. The inflatable chamber may include a plurality of extensible pleats that expand in response to the injection of inflation gas into the chamber.

The knee bolster cover of the present invention thus provides substantial advantages over conventional knee bolster covers. The knee bolster cover is inexpensive in that both high-performance engineering materials and low-cost commodity materials are used to make the cover. In addition, the knee bolster cover of the present invention is unitary in design and does not require the installation of a separate knee bolster cover and a surrounding cosmetic cover. Furthermore, the knee bolster cover is versatile and may be used in connection with a wide variety of knee bolster systems and vehicles.

These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and features of the invention are obtained, a more particular description of the invention summarized above will be rendered by reference to the appended drawings. Understanding that these drawings illustrate only selected embodiments of the invention and are not therefore to be considered limiting in scope, the invention will be described and explained with additional specificity and detail through the use of the accompanying drawings in which:

FIG. 1 is a front perspective view of a knee bolster cover of the present invention;

FIG. 2 is a rear perspective view of the knee bolster cover shown with an inflatable chamber; and

FIG. 3 is a front perspective view of a first and a second knee bolster cover installed in a vehicle and shown in a deployed condition.

### DETAILED DESCRIPTION OF THE PREFERRED EMBODIMENTS

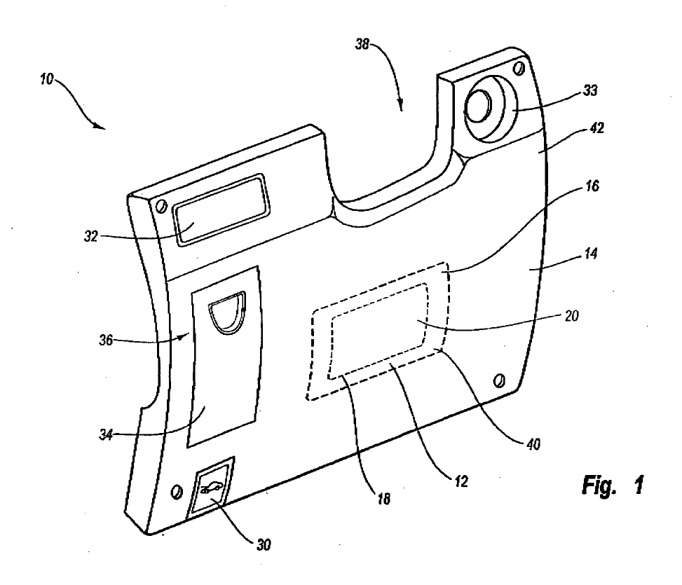

The preferred embodiments of the invention are now described with reference to FIGS. 1-3, wherein like parts are designated by like numerals throughout. The members of the present invention, as generally described and illustrated in the Figures, may be designed in a wide variety of configurations. Thus, the following more detailed description of the embodiments of the present invention, as represented in the Figures, is not intended to limit the scope of the invention, as claimed, but is merely representative of presently preferred embodiments of the invention.

In this application, the phrases “connected to,” “coupled to,” and “in communication with” refer to any form of interaction between two or more entities, including mechanical, electrical, magnetic, electromagnetic, electromechanical and thermal interaction. The phrase “attached to” refers to a form of mechanical coupling that restricts relative translation or rotation between the attached objects. The phrases “pivotally attached to” and “slidably attached to” refer to forms of mechanical coupling that permit relative rotation or relative translation, respectively, while restricting other relative motion.

The phrase “directly attached to” refers to a form of attachment by which the attached items are either in direct contact, or are only separated by a single connector, adhesive, or other attachment mechanism. The term “abutting” refers to items that are in direct physical contact with each other, although the items may not be attached together.

With reference to FIG. 1, a front perspective view of a knee bolster cover 10 of the present invention is shown. The knee bolster cover 10 includes a knee bolster region 12 and a peripheral region 14.

In the illustrated embodiment, the knee bolster region 12 has a generally planar exposed surface 16. In alternative embodiments, the knee bolster region 12 may have a rounded or curved exposed surface 16. A tear seam 18 is disposed around at least a portion 20 of the knee bolster region 12. As illustrated, the tear seam 18 is positioned entirely within the knee bolster region 12. In an alternative embodiment, the tear seam is disposed between the knee bolster region 12 and the peripheral region 14. As will be explained in detail below, the tear seam 18 ruptures to permit the portion 20 of the knee bolster region 12 to separate from the remainder of the cover 10 and receive an occupant impact.

Those of skill in the art will understand that the tear seam 18 may be formed using a number of different techniques, such as scoring, perforations, or the use of separate pieces (not shown) attached together. If separate pieces are used, the pieces may be attached to each other using adhesives, stitching, clips or other mechanical fastening devices.

As shown in FIG. 1, the peripheral region 14 surrounds at least a portion of the knee bolster region 12 and extends in a generally lateral direction away from the knee bolster region 12. The peripheral region 14 and knee bolster region 12 of FIG. 1 are generally coplanar. In alternative embodiments, the peripheral region 14 is angled or offset with respect to the knee bolster cover 10. The peripheral region 14 may be disposed entirely around the knee bolster region 12 or may extend around only a portion of the knee bolster region 12.

The peripheral region 14 is shaped to interface with and provide a cosmetic cover to components of a vehicle (not shown). For example, the peripheral region 14 may include a hood latch interface 30, an air vent interface 32, an ignition key assembly interface 33, a storage compartment 34, a storage compartment interface 36, and a steering wheel inlet 38. The peripheral region 14 is versatile and may be designed to interface with a wide variety of components in a vehicle.

The knee bolster region 12 is made from a first material 40, and the peripheral region 14 is made from a second material 42. The first material 40 has higher performance requirements than the second material 42 because the portion 20 of the knee bolster region 12 is displaced and receives an occupant impact during an accident. The second material 42, in contrast, is required only to meet the lower standards needed for decorative trim and molding within a vehicle.

Those skilled in the art will recognize that the first and second materials 40, 42 may comprise a wide variety of compounds, mixtures, or substances to achieve the purposes delineated above. For example, the first material 40 may comprise high performance polymers, such as styrene-ethylene-butylene-styrene copolymers (SEBS), styrene block copolymers, styrene-butadiene copolymers, polyolefin elastomers, polyesters, or nylons. Polyolefin elastomers include, for example, polyethylene and polypropylene elastomers. In contrast, the second material 42 may comprise what is frequently referred to as commodity plastics, such as polypropylene, polyethylene, acrylonitrile butadiene styrene (ABS), polyvinyl chloride (PVC), and acrylonitrile butadiene styrene (ABS)/polycarbonate (PC) alloys.

In one embodiment, the first material 40 has a greater density than the second material 42. For example, the first material 40-may be 10 to 20% more dense than the second material 42. In addition, the first material 40 may have a lower flex modulus and tensile strength than the second material 42. In one embodiment, the second material 42 has a tensile strength of 4400-6300 psi and a flex modulus of 179-375 Kpsi, while the first material 40 has a tensile strength of 1250-2200 psi and a flex modulus of 11-60 Kpsi. In one embodiment, the first material 40 is more flexible and/or elastic than the second material 42. For example, the first material 40 may have a percentage elongation at yield in excess of 300%, while the second material 42 may have a percentage elongation at break of only 5-75%.

The high-quality materials from which the knee bolster region 12 is made are not required for the peripheral region 14. Accordingly, significant cost savings can be achieved by using commodity grade plastics for the peripheral region 14.

The knee bolster region 12 and peripheral region 14 are bonded together during a molding process. Thus, a two- or multi-shot molding process is used. Alternatively, a simultaneous co-injection process could be used to form the cover 10.

To achieve a bond during the molding process, the first and second materials 40, 42 should be compatible with each other. For example, if polymeric alloys are used, one component of each alloy should be common to the first and second materials 40, 42. A polymeric alloy is a blend of two or more polymers. Acrylonitrile butadiene styrene (ABS)/polycarbonate (PC) is one example of a polymeric alloy.

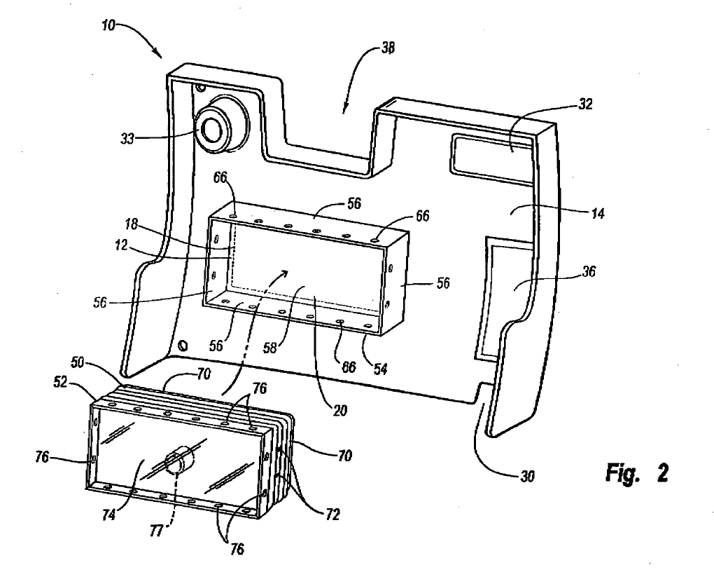

Referring now to FIG. 2, there is shown a rear perspective view of the knee bolster cover 10. FIG. 2 also illustrates an inflatable chamber 50 having a chamber bracket 52, which is used to attach the inflatable chamber 50 to the knee bolster cover 10.

As explained above, the cover 10 has a knee bolster region 12 and a peripheral region 14. The cover 10 additionally includes a tear seam 18 disposed around the portion 20 of the knee bolster region 12. The peripheral region 14 interfaces with and provides a cosmetic cover to components of a vehicle (not shown) disposed proximate an inflatable chamber 50. Thus, the peripheral region 14 may include various interfaces, such as a hood latch interface 30, an air vent interface 32, an ignition key assembly interface 33, a storage compartment interface 36, and a steering wheel inlet 38. As noted above, the cover 10 may be designed and shaped to interface with a wide variety of components in a vehicle.

The cover 10 optionally includes a receiving bracket 54 for receiving and securing an inflatable chamber 50 to the cover 10. The illustrated receiving bracket 54 includes four sides 56 that form an opening 58 for receiving the inflatable chamber 50. A series of holes 66 are formed in the receiving bracket 54 to receive mechanical fasteners (not shown), such as bolts, screws, pins, or rivets, for securing the chamber bracket 52 of the inflatable chamber 50 to the cover 10.

Those of skill in the art will recognize that the receiving bracket 54 may be embodied in a number of different configurations. For example, the receiving bracket 54 may have only two sides 56 disposed on opposing sides of the opening 58. In addition, the holes 66 may be omitted. In such an embodiment, adhesives or welding, for example, may be used to secure the chamber bracket 52 of the inflatable chamber 50 to the cover 10.

As stated above, the knee bolster cover 10 receives and is secured to an inflatable chamber 50. The inflatable chamber 50 is made from a malleable material, such as steel or other metals. Alternatively, the inflatable chamber 50 may be made from blown or injection molded plastics.

The inflatable chamber 50 illustrated in FIG. 2 includes a series of extensible pleats 70. The extensible pleats 70 are shown in a compressed condition in FIG. 2. When the inflatable chamber 50 receives pressurized inflation gas, the extensible pleats 70 expand and the inflatable chamber 50 enlarges to receive and dissipate the energy of an occupant impact.

The inflatable chamber 50 may include one or more gas vents 72. The gas vents 72 can serve at least two purposes. In one embodiment of the inflatable chamber 50, the material from which the inflatable chamber 50 is made is sufficiently rigid to receive and dissipate the occupant energy during impact without retaining pressurized gas in the chamber 50. Accordingly, the gas pressure within the inflatable chamber 50 is not needed to absorb occupant energy. In this embodiment, the gas vents 72 permit dissipation of the gas pressure within the inflatable chamber 50.

In an alternative embodiment, gas pressure within the inflatable chamber 50 assists in dissipating the energy of the occupant impact. Thus, the gas vents 72 permit inflation gas to exit the inflatable chamber 50 in response to the occupant impact, further dissipating and absorbing the occupant energy.

The inflatable chamber 50 may be embodied in a wide variety of configurations. For example, in an alternative embodiment, the inflatable chamber 50 is made from a flexible material, such as fabric. In such an embodiment, various folding techniques, beyond the use of extensible pleats 70, may be used.

A chamber bracket 52 is attached to the inflatable chamber 50. Thus, the chamber bracket 52 may be separately manufactured and secured to the inflatable chamber 50 using mechanical fasteners, such as screws, bolts, heat or pressure welding, or adhesives. Alternatively, the chamber bracket 52 is integrally formed with the inflatable chamber 50 or a rear panel 74 of the inflatable chamber 50.

Apertures 76 in the chamber bracket 52 are positioned on the chamber bracket 52 to be aligned with holes 66 in the receiving bracket 54. As a result, when the chamber bracket 52 and inflatable chamber 50 are positioned within the opening 58, mechanical fasteners (not shown), such as bolts, rivets, or screws, may be positioned within the holes 66 and apertures 76 to secure the chamber bracket 52 to the receiving bracket 54. In one embodiment, the holes 66 and/or apertures 76 are threaded for receiving threaded fasteners (not shown), such as screws or bolts.

The chamber bracket 52 and inflatable chamber 50 may be embodied in a number of different ways. For example, in one embodiment, the apertures 76 are omitted and adhesives or welding are used to secure the chamber bracket 52 to the cover 10. Alternatively, apertures 76 may be formed in the inflatable chamber 50, and a separate chamber bracket 52 is not required. In yet another alternative embodiment, the chamber bracket 52 is omitted and apertures 76 are omitted from the inflatable chamber 50. In such an embodiment, adhesives or welding may be used to secure the inflatable chamber 50 to the cover 10.

An inflator 77 is in fluid communication with the inflatable chamber 50. The inflator 77 generates pressurized gas for inflation of the chamber 50. As illustrated, the inflatable chamber 50 is attached to and disposed within the chamber 50. In an alternative embodiment, the inflator 77 is partially positioned within the inflatable chamber 50. In yet another embodiment, the inflator 77 is remotely positioned with respect to the chamber 50 and is in fluid communication with the chamber 50 via a gas guide (not shown).

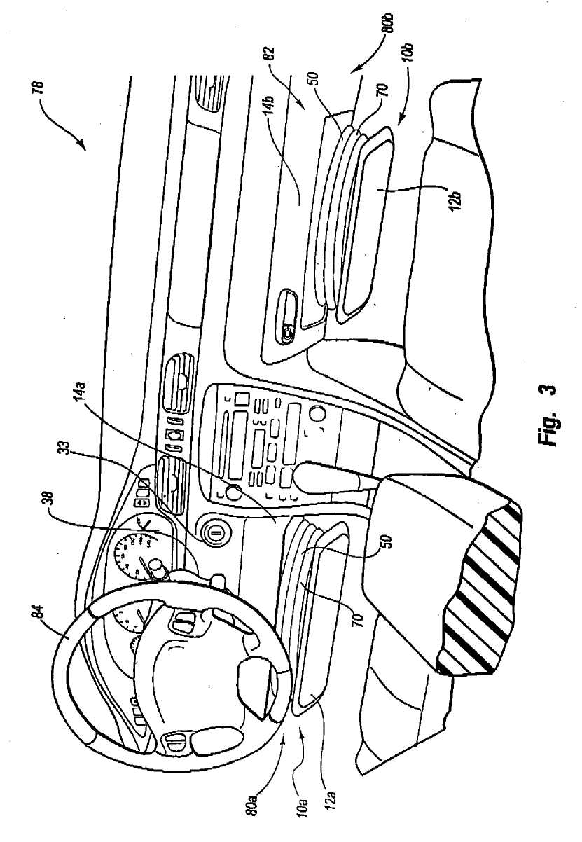

FIG. 3 shows a perspective view of a first and a second knee bolster cover 10a-b installed in a vehicle 78. Each of the covers 10a-b is shown following deployment of the attached inflatable chamber 50. Thus, the extensible pleats 70 of each chamber 50 are shown in an extended position.

As shown by FIG. 3, the cover 10 of the present invention is versatile and can be used in connection with a driver's side knee bolster 80a and a passenger's side knee bolster 80b. Accordingly, the knee bolster region 12a-b may be embodied as an exterior portion 12b of a glove compartment 82 or as a panel 12a situated under the steering wheel 84. The peripheral region 14a-b may be embodied as an exterior portion 14b of the glove compartment 82 or as a decorative panel 14a disposed adjacent to or near the steering wheel 84. As illustrated in FIG. 3, the peripheral region 14a may include an ignition key assembly interface 33, and a steering wheel inlet 38.

In an alternative embodiment, the cover 10b for the passenger's side knee bolster 80b is not integrated with the glove compartment 82. Thus, the cover 10b may be situated below the glove compartment 82, or, alternatively, the glove compartment 82 could be omitted from the vehicle 78.

The knee bolster cover of the present invention thus provides substantial advantages over conventional knee bolster covers. The knee bolster cover is inexpensive in that both high-performance engineering materials and low-cost commodity materials are used to make the cover. In addition, the knee bolster cover of the present invention is unitary in design and does not require the installation of a separate knee bolster cover and surrounding cosmetic cover. Furthermore, the knee bolster cover is versatile and may be used in connection with a wide variety of knee bolster systems and vehicles.

The present invention may be embodied in other specific forms without departing from its structures, methods, or other essential characteristics as broadly described herein and claimed hereinafter. The described embodiments are to be considered in all respects as only illustrative, and not restrictive. The scope of the invention is, therefore, indicated by the appended claims, rather than by the foregoing description. All changes that come within the meaning and range of equivalency of the claims are to be embraced within their scope.

1. A knee bolster cover for a vehicle, comprising:
a knee bolster region formed from a first material during a molding process, the knee bolster region being attachable to an inflatable chamber; and
a peripheral region formed from a second material during the molding process, the peripheral region being shaped to interface with and provide a cosmetic cover to at least one component of a vehicle disposed proximate the inflatable chamber, wherein the knee bolster and peripheral regions are bonded together during the molding process.

2. The cover of claim 1, wherein the peripheral region surrounds at least a portion of the knee bolster region.

3. The cover of claim 2, further comprising a tear seam disposed around at least a portion of the knee bolster region.

4. The cover of claim 1, wherein the first material has a greater percentage elongation at yield than the second material.

5. The cover of claim 1, wherein the first material has a lower tensile strength than the second material.

6. The cover of claim 1, wherein the first material is a styrene-ethylene-butylene-styrene copolymer (SEBS), a styrene-butadiene copolymer, or a polyolefin elastomer.

7. The cover of claim 1, wherein the second material is polypropylene, polyethylene, acrylonitrile butadiene styrene (ABS), polyvinyl chloride (PVC), or an acrylonitrile butadiene styrene (ABS)/polycarbonate (PC) alloy.

8. The cover of claim 1, wherein the tear seam ruptures in response to expansion of the inflatable chamber to permit at least a portion of the knee bolster region to separate from the peripheral region.

9. The cover of claim 1, wherein the inflatable chamber is made from a malleable material.

10. The cover of claim 9, wherein the inflatable chamber is made from steel.

11. The cover of claim 9, wherein the inflatable chamber comprises at least one extensible pleat.

12. The cover of claim 9, further comprising a gas vent disposed in the inflatable chamber.

13. The cover of claim 1, further comprising an inflator disposed within the inflatable chamber.

14. The cover of claim 1, wherein the peripheral region includes interfaces selected from a group consisting of a hood latch interface, an air vent interface, an ignition key assembly interface, and a storage compartment interface.

15. The cover of claim 1, wherein the first and second materials are polymeric alloys having a common alloy component.

16. A knee bolster cover for a vehicle, comprising:
a knee bolster region formed from a first material during a molding process, the knee bolster region being attachable to an inflatable chamber; and
a peripheral region formed from a second material during the molding process, the peripheral region extending in a generally lateral direction away from the knee bolster region and being shaped to interface with and provide a cosmetic cover to at least one component of a vehicle disposed proximate the inflatable chamber, wherein the knee bolster and peripheral regions are bonded together during the molding process.

17. The cover of claim 16, wherein the knee bolster region and the peripheral region are generally coplanar.

18. The cover of claim 16, wherein the peripheral regions surrounds at least a portion of the knee bolster region.

19. The cover of claim 18, further comprising a tear seam disposed around at least a portion of the knee bolster region.

20. The cover of claim 16, wherein the first material has a greater percentage elongation at yield than the second material.

21. The cover of claim 16, wherein the first material is a styrene-ethylene-butylene-styrene copolymer (SEBS), a styrene-butadiene copolymer, or a polyolefin elastomer.

22. The cover of claim 16, wherein the second material is polypropylene, polyethylene, acrylonitrile butadiene styrene (ABS), polyvinyl chloride (PVC), or an acrylonitrile butadiene styrene (ABS)/polycarbonate (PC) alloy.

23. The cover of claim 16, wherein the tear seam ruptures in response to expansion of the inflatable chamber to permit at least a portion of the knee bolster region to separate from the peripheral region.

24. The cover of claim 16, wherein the inflatable chamber is made from a malleable material.

25. The cover of claim 16, wherein the peripheral region includes interfaces selected from a group consisting of a hood latch interface, an air vent interface, an ignition key assembly interface, and a storage compartment interface.

26. The cover of claim 16, wherein the first and second materials are polymeric alloys having a common alloy component.

27. A knee bolster cover for a vehicle, comprising:
a knee bolster region formed from a first material during a molding process, the knee bolster region being attachable to an inflatable chamber; and
a peripheral region formed from a second material during the molding process, the peripheral region extending in a generally lateral direction away from the knee bolster region and being shaped to interface with and provide a cosmetic cover to at least one component of a vehicle disposed proximate the inflatable chamber, wherein the first material has a lower flex modulus than the second material, and wherein the knee bolster and peripheral regions are bonded together during the molding process.

28. The cover of claim 27, wherein the knee bolster region and the peripheral region are generally coplanar.

29. The cover of claim 27, wherein the peripheral regions surrounds at least a portion of the knee bolster region.

30. The cover of claim 29, further comprising a tear seam disposed around at least a portion of the knee bolster region.

31. The cover of claim 27, wherein the first material has a greater percentage elongation at yield than the second material.

32. The cover of claim 27, wherein the tear seam ruptures in response to expansion of the inflatable chamber to permit at least a portion of the knee bolster region to separate from the peripheral region.

33. The cover of claim 27, wherein the inflatable chamber is made from a malleable material.

34. The cover of claim 33, wherein the inflatable chamber comprises at least one extensible pleat.

35. A knee bolster cover for a vehicle, comprising:
a knee bolster region means for receiving an occupant's lower leg during an accident, the knee bolster region means being formed from a first material during a molding process, the knee bolster region means being attachable to an inflatable chamber; and
a peripheral region means for interfacing with and providing a cosmetic cover to at least one component of a vehicle disposed proximate the inflatable chamber, the peripheral region means being formed from a second material during the molding process, wherein the knee bolster and peripheral region means are bonded together during the molding process.
